(19) United States
(12) Patent Application Publication
(10) Pub. No.: US 2021/0278565 A1
(43) Pub. Date: Sep. 9, 2021

(54) DETECTING ABNORMAL METROLOGICAL DRIFT IN A FLUID METER

(71) Applicant: SAGEMCOM ENERGY & TELECOM SAS, Rueil Malmaison (FR)

(72) Inventor: Henri TEBOULLE, Rueil Malmaison (FR)

(21) Appl. No.: 17/192,655

(22) Filed: Mar. 4, 2021

(30) Foreign Application Priority Data
Mar. 5, 2020 (FR) 2002244

(51) Int. Cl. G01W 1/18; G01W 1/10

(52) U.S. Cl. CPC G01W 1/18; G01W 1/10

(57) ABSTRACT

A method of monitoring a fluid meter is arranged to produce measurements of the overall consumption of an installation. The method includes the steps of: analyzing the overall consumption measurements to identify a mechanism in the installation that operates with operating cycles, each presenting a substantially constant cycle duration (t1−t0) and during each of which the individual consumption (V1−V0) of the mechanism is substantially constant; detecting operating cycles of the mechanism and measuring the individual consumption of the mechanism for each detected operating cycle; detecting abnormal metrological drift of the measuring device as a function of variation over time in the individual consumption.

The invention relates to the field of smart fluid meters.

### BACKGROUND OF THE INVENTION

Modern water meters, known as “smart meters”, are progressively replacing traditional water meters.

A smart water meter is naturally capable of measuring the quantity of water consumed by a client's installation in order to bill the client for that consumption. A smart water meter is also capable of producing, transmitting, receiving, and analyzing various kinds of data (e.g. relating to the consumption of the installation, to the state of the water distribution network, or indeed to the operation of the meter), so as to be able to perform new functions. These new functions benefit the water distributor, the network operator, and the client.

By way of example, a smart water meter thus enables the client to improve monitoring of the client's own consumption and thus to control it better, to optimize billing, and, as a result of remote reading, to avoid being disturbed by the visits of meter readers.

In smart water meters, and indeed in traditional water meters, it is appropriate to ensure that the measuring device (e.g. an ultrasonic device) conserves over time the accuracy that was specified when it was designed. Nevertheless, it is very complicated to detect the appearance of abnormal metrological drift in the measuring device of a water meter. However, such abnormal metrological drift could have significant financial consequences for the client, or indeed conversely for the water distributor if the phenomenon arises in a large number of meters.

### OBJECT OF THE INVENTION

An object of the invention is to detect abnormal metrological drift of a measuring device of a fluid meter.

### SUMMARY OF THE INVENTION

In order to achieve this object, there is provided a monitoring method for monitoring a measuring device of a fluid meter that is arranged to produce measurements of the overall consumption of an installation, the method comprising the steps of:
analyzing the overall consumption measurements to identify a mechanism in the installation that operates with operating cycles, each presenting a substantially constant cycle duration and during each of which the individual consumption of the mechanism is substantially constant;
detecting the operating cycles of the mechanism and measuring the individual consumption of the mechanism for each detected operating cycle;
detecting abnormal metrological drift of the measuring device of the fluid meter as a function of variation over time in the individual consumption of the mechanism.

The monitoring method of the invention thus consists in using the overall consumption measurements to identify a particular mechanism within the installation (e.g. a toilet flush), which mechanism presents individual consumption that is substantially constant each time it is activated. The monitoring method then consists in following the variation over time in the individual consumption measurements, which measurement should normally be substantially constant in the absence of any drift in the measuring device, and in detecting abnormal drift in the measuring device of the fluid meter when the measurements drift abnormally. The monitoring method is thus particularly advantageous: drift of the meter is detected without directly monitoring the measuring device, but by using a “standard” mechanism that has been identified in the installation for which the fluid meter measures consumption.

There is also provided a monitoring method as described above, wherein identifying the mechanism comprises the steps of:
detecting, in the overall consumption measurements, a reference operating cycle having a cycle duration and an individual consumption that are substantially equal to a previously-input cycle duration and to a previously-input individual consumption corresponding to a known mechanism;
associating the mechanism with a reference cycle duration equal to the cycle duration of said reference operating cycle and with a reference individual consumption equal to the individual consumption of said reference operating cycle.

There is also provided a monitoring method as described above, wherein detecting an operating cycle comprises the steps of detecting, in the overall consumption of the installation, a succession of a first stable stage, of an increasing stage, and of a second stable stage.

There is also provided a monitoring method as described above, further comprising a step of detecting a change of mechanism from a variation in the cycle duration and/or from a variation in the individual consumption of the mechanism.

There is also provided a monitoring method as described above, wherein an identical replacement of the mechanism is detected when, starting from a first change time, the cycle duration no longer lies in a first interval centered on the reference cycle duration and the individual consumption no longer lies in a second interval centered on the reference individual consumption.

There is also provided a monitoring method as described above, wherein replacement of the mechanism by a non-identical mechanism is detected when, from a second change time, the cycle duration no longer lies in a third interval centered on the reference cycle duration and the individual consumption no longer lies in a fourth interval centered on the reference individual consumption, the third interval and the fourth interval being wider than the first interval and the second interval.

There is also provided a monitoring method as described above, wherein detecting abnormal metrological drift comprises the steps of:
evaluating a drift function representative of drift of the individual consumption of the mechanism;
detecting abnormal metrological drift when the function remains less than or equal to a predetermined threshold for a predetermined duration, and then, starting from a drift time and under the effect of abnormal metrological drift, the individual consumption no longer lies in a fifth interval centered on the reference individual consumption.

There is also provided a monitoring method as described above, wherein the drift function is the average of the slopes of segments, each connecting together two successive measurement points, each measurement point having as its coordinates the time at which an individual consumption measurement is taken, and said individual consumption measurement.

There is also provided a monitoring method as described above, wherein the mechanism is a flush.

There is also provided a fluid meter including a measuring device and a processor module arranged to perform the monitoring method as described above.

There is also provided a computer program including instructions for causing the above-described fluid meter to execute the steps of the above-described monitoring method.

There is also provided a computer readable storage medium, storing the above-described computer program.

The invention can be better understood in the light of the following description of a particular, nonlimiting embodiment of the invention.

### BRIEF DESCRIPTION OF THE DRAWING

Reference is made to the accompanying drawing, in which:

FIG. 1 shows a graph plotting a curve of measurements of overall consumption in an installation;

FIG. 2 shows a graph plotting a curve of consumption by an individual flushing system, while abnormal metrological drift is taking place in the water meter.

### DETAILED DESCRIPTION OF THE INVENTION

In this example, the monitoring method of the invention is performed to detect abnormal metrological drift in a measuring device of a water meter.

The water meter measures the overall water consumption of an installation, e.g. situated in a dwelling.

In addition to the measuring device, the water meter includes a processor module. The processor module comprises at least one processor component adapted to execute instructions of a program for performing the steps of the monitoring method as described below. By way of example, the processor component may be a processor, a microcontroller, or indeed a programmable logic circuit such as a field programmable gate array (FPGA) or an application-specific integrated circuit (ASIC).

The invention consists firstly in identifying a particular water-consuming mechanism in the installation by analyzing the overall consumption measurements of the installation as produced by the measuring device of the water meter. This mechanism operates in operating cycles, each of which presents a cycle duration that is substantially constant and during each of which the individual consumption of the mechanism is substantially constant. Thereafter, the invention consists in detecting the operating cycles of that mechanism, and in measuring the individual consumption of the mechanism for each of its detected operating cycles. The invention then consists in detecting the occurrence of abnormal metrological drift when the measurements of the individual consumption drift abnormally over time, even though they ought to be substantially constant, since the individual consumption of the mechanism over each operating cycle is substantially constant.

It can thus be understood that a distinction is drawn between the overall consumption of the installation as a whole, as measured by the water meter, and the individual consumption of the mechanism, which is measured in a manner described below.

In this example, the mechanism in question is a flush. Specifically, it is known that a conventional flush typically consumes a substantially constant volume of water, lying in the range 9 liters (L) to 12 L, and that the time taken to refill the tank of a conventional flush is substantially constant and is of the order of a few tens of seconds once the flush has been engaged.

The monitoring method thus consists firstly in identifying the flush from within the overall consumption measurements made by the water meter.

To do this, the processor component acquires the overall consumption measurements and then detects a reference operating cycle having a cycle duration and an individual consumption that are respectively substantially equal to a previously-input cycle duration and to a previously-input individual consumption corresponding to a known mechanism, specifically a known type of conventional flush.

The previously-input cycle duration and the previously-input individual consumption correspond respectively to the above-mentioned time taken to fill the tank of a flush and to the substantially constant volume of water. The term “previously-input” is used to mean that the data is previously obtained and then stored, either in the water meter or else in some other system (a data concentrator, an information system (IS), etc.), in which case the stored data is subsequently acquired by the water meter.

The processor component of the water meter then associates the flush with a reference cycle duration equal to the duration of the reference operating cycle and with a reference individual consumption equal to the individual consumption of the reference operating cycle. These reference measurements form a reference pair.

Detecting an operating cycle in the overall consumption measurements, and thus in particular detecting the reference operating cycle, consists in detecting, in the overall consumption of the installation, a succession of a first stable stage, of an increasing stage, and of a second stable stage.

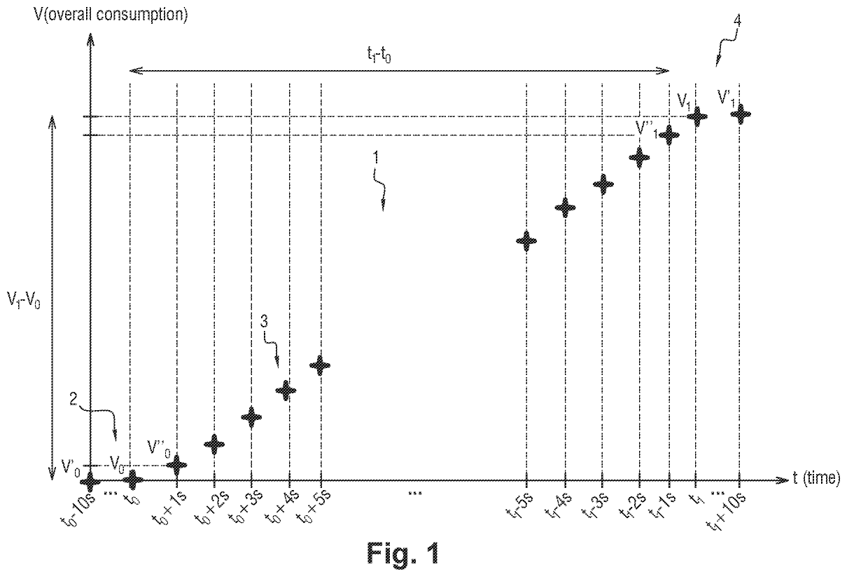

In the overall consumption measurements of FIG. 1, there can be seen a reference operating cycle 1.

Detecting the first stable stage 2 and the increasing stage 3 consists in detecting the absence of any overall water consumption in the installation during at least a predetermined duration, followed by a relatively rapid increase in the overall consumption.

It is therefore sought to identify a time to that satisfies both:

V₀−V′₀≤ΔV₀,

and also:

V′₀−V₀>ΔV′₀,

where V₀ is the overall consumption of the installation up to the time to, V′₀ is the overall consumption up to the time t₀−Δt₀, and V″₀ is the overall consumption up to the time t₀+Δt′₀.

In this example:

Δt₀=10 seconds (s);
Δt′₀=1 s;

### ΔV₀=0.1 L;

### ΔV′₀=0.1 L.

In this example, the first stable stage 2 thus extends from t₀−10 s to t₀. The increasing stage 3 starts from t₀, i.e. after observing at least 10 seconds of stability in the overall consumption, and it includes the time interval from t₀ to t₀+1 s.

Detecting the second stable stage 4 then consists once more in detecting stability in the overall water consumption after the increasing stage 3.

It is therefore sought to identify a time t₁ that satisfies both:

V′₁−V₁≤ΔV₁,

and also:

V₁−V″₁>ΔV′₁,

where V₁ is the overall consumption up to the time t₁, V′₁ is the overall consumption up to the time t₁+Δt₁, and V″₁ is the overall consumption up to the time t₁−Δt′₁.

In this example:

Δt₁=10 s;
Δt′1=1 s;

### ΔV₁=0.1 L;

### ΔV′1=0.1 L.

The processor component then calculates the difference between the overall consumption V₁ (corresponding to the consumption up to the second stable stage 4) and the overall consumption V₀ (corresponding to the consumption up to the first stable stage 2), in order to obtain a measurement of the individual consumption in the operating cycle 1. The duration from t₀ to t₁ corresponds to the duration of the operating cycle.

The processor component then compares the individual consumption V₁−V₀ and the cycle duration t₁−t₀ with the previously-input individual consumption and the previously-input cycle duration.

In this example, this gives:

V₁−V₀=9.8 L and t₁−t₀=38 s.

This data is substantially equal to the previously-input data and does indeed correspond to a flush: the operating cycle 1 is indeed a reference operating cycle, defined by a reference cycle duration (t₁−t₀) and by a reference individual consumption (V₁−V₀). The processor component associates the flush with the reference cycle duration and with the reference individual consumption.

Advantageously, in order to validate and consolidate the reference measurements, provision is made to repeat them several times under similar conditions, e.g. 5 times. The reference measurements are validated if the variations in the reference cycle time and the reference individual consumption are small.

The symbol t̅ designates the mean of the 5 measured reference cycle durations, and the symbol V̅ designates the mean of the 5 measured reference individual consumptions.

It is considered that the measurement of the reference cycle duration is confirmed if all 5 measurements lie in a first reference interval centered on t̅ and defined by t̅±5%.

It is considered that the measurement of the reference individual consumption is confirmed if all 5 measurements lie in a second reference interval centered on V̅ and defined by V̅±5%.

Once the measurements are confirmed, the processor component defines as the “confirmed” reference cycle duration the mean t̅ of the reference cycle durations, and as the “confirmed” reference individual consumption, the mean V̅ of the reference individual consumptions. The processor component associates the reference pair (V̅,t̅) with the flush.

It should be observed that, in the event of there being one or more other mechanisms present, e.g. in the event of a second flush being present, or indeed in the event of the flush having a small flush mechanism and a large flush mechanism, the processor component identifies these other mechanisms in similar manner and associates them in similar manner with their own respective reference cycle durations t̅ and with their own respective reference individual consumptions V̅.

As time passes, the processor component then detects “current” operating cycles of the flush, and for each detected operating cycle, it measures the cycle duration and the individual consumption of the flush. These operating cycles are detected in the same manner as the reference operating cycle is detected (detecting the first stable stage, the increasing stage, and the second stable stage). The cycle duration and the individual consumption are also measured in the same manner as the reference cycle duration and the reference individual consumption.

Detecting operating cycles serves firstly to detect any change of the flush on the basis of any variation in the cycle duration and/or any variation in the individual consumption of the flush.

A detected change of the flush may correspond either to the flush being replaced by an identical flush (or to the flush being renovated), or else to the flush being replaced by a non-identical flush. The processor component detects these two types of change and distinguishes between them.

An identical replacement of the flush is detected when, starting from a first change time, the cycle duration no longer lies in a first interval centered on the reference cycle duration and the individual consumption no longer lies in a second interval centered on the reference individual consumption (even though, previously, they used to lie in those intervals).

A replacement of the flush with a non-identical mechanism is detected when, starting from a second change time, the cycle duration no longer lies in a third interval centered on the reference cycle duration and the individual consumption no longer lies in a fourth interval centered on the reference individual consumption (even though, previously, they used to lie in those intervals). The third interval and the fourth interval are wider than the first interval and the second interval.

By way of example, the first interval may be defined by t̅±5%, the second interval by V̅±5%, the third interval by t̅±10%, and the fourth interval by V̅+10%.

Thus, in the event that, over a certain duration, the cycle duration and the individual consumption are included to within a certain margin respectively in the first interval t̅±5% and in the second interval V̅±5%, and then, suddenly, the cycle duration and the individual consumption lie outside the first interval and the second interval, but still within the third interval t̅±10% and the fourth interval V̅±10%, the processor component detects that the flush has been replaced identically.

The processor component then determines a new reference cycle duration t̅′ and a new reference individual consumption V̅′ and it replaces the reference pair (V̅′,t̅′) with the new reference pair (V̅′, t̅′).

In contrast, in the event that, over a certain duration, the cycle duration and the individual consumption are included to within a certain margin in the first interval t̅±5% and in the second interval V̅±5%, and that, suddenly, the cycle duration and the individual consumption lie outside the third interval t̅±10% and the fourth interval V̅±10%, the processor component detects that the flush has been replaced by a non-identical flush.

The processor component then determines a new reference cycle duration t̅′ and a new reference individual consumption V̅′ and thus creates the new reference pair (V̅′, t̅′) while conserving the existing reference pair (V̅, t̅).

The processor component can thus store one or more reference measurements for a single installation by means of the pairs (V̅, t̅) and it can update them in real time.

Detecting operating cycles also serves to detect abnormal metrological drift of the measuring device of the water meter. When the processor component has determined at least one reference pair (V̅, t̅) and when it has stored this reference pair, the water meter goes into a standby mode (which does not prevent it from acting in parallel to find other mechanisms that have not yet been detected, and/or to find changes of the mechanisms that have been identified).

When the water meter is in standby mode, it attempts to detect abnormal metrological drift from variation in the individual fluid consumption of the flush as obtained from the measurements of overall consumption.

For each of the identified mechanisms, standby mode consists in measuring once again 5 consecutive periods corresponding to use of that mechanism. This obtains successive pairs, written (V̅ₙ,t̅ₙ) for a mechanism that has the reference pair (V̅,t̅) and which has never been detected as changed by the processor component (identical replacement or replacement by a non-identical mechanism).

Detecting abnormal metrological drift consists firstly in evaluating a drift function representative of drift in the individual consumption of the flush.

In this example, the drift function may be as follows:

$${P}_{n} = \frac{1}{k} {\sum }_{i = 0}^{i = k - 1} {\overline{( V}}_{n - 1} - {\overline{V}}_{n - i - 1} \text{)} / {T}_{n - i}$$

where Tₙ₋ᵢ is the time that elapses between the measurements V̅ₙ₋ᵢ and V̅ₙ₋ᵢ₋₁.

The drift function is thus the average of the slopes of segments, each connecting together two successive measurement points, each measurement point having as its coordinates the time at which an individual consumption measurement is taken and said individual consumption measurement.

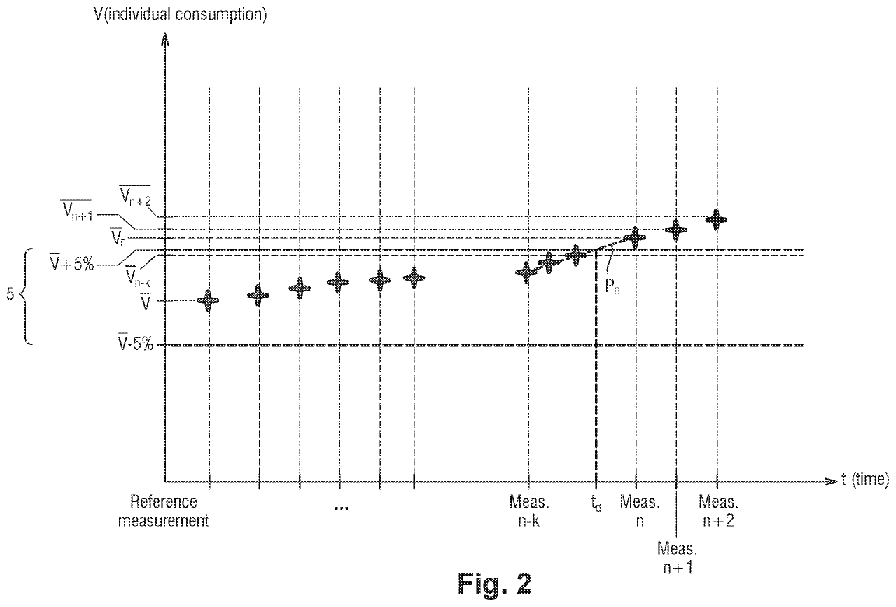

The drift function Pₙ can be seen in FIG. 2.

The processor component detects abnormal metrological drift when the print function remains less than or equal to a predetermined threshold during a relatively long predetermined drift duration (thus a slow drift is detected first), and then, starting from a drift time t_{d}, and under the effect of the drift, the individual consumption no longer lies in a fifth interval 5 centered on the reference individual consumption V̅.

Thus, abnormal metrological drift is detected when the drift function Pₙ is such that:

Pₙ≤S_{d},

assuming that k is great enough for:

Σᵢ₌₀^{i=k}Tₙ₋ᵢ≥D_{d},

and that under the effect of the current drift, the individual consumption no longer lies in the fifth interval 5.

S_{d} is the predetermined drift threshold, which for example is equal to 0.1 L/month.

D_{d} is the predetermined drift duration, e.g. equal to 3 months.

In this example, the fifth interval 5 is defined as V̅±5%.

Advantageously, it is ensured that at least three consecutive values (V̅ₙ,V̅ₙ₊₁,V̅ₙ₊₂) of the individual consumption no longer lie in the fifth interval 5 before detecting abnormal metrological drift.

It should be observed that it is possible to deduce Pₙ₊₁ from Pₙ by the following formula:

$${P}_{n + 1} = {P}_{n} + \frac{1}{k} \times [ \frac{\overline{( {V}_{n + 1}} - \overline{{V}_{n} )}}{{T}_{n + 1}} - \frac{( \overline{{V}_{n - k + 1}} - \overline{{V}_{n - k}} )}{{T}_{n - k + 1}} ] .$$

This avoids using the above-described formula for Pₙ, thereby simplifying calculation and thus simplifying the resources of the processor component used for performing the monitoring method.

When the water meter has detected abnormal metrological drift, it returns an anomaly message to the Information System.

Naturally, the invention is not limited to the embodiment described, but covers any variant coming within the ambit of the invention as defined by the claims.

The invention is not necessarily performed in the fluid meter, and it could be performed in full or in part in one or more other pieces of equipment: a data concentrator, a district meter, a server of the Information System, etc.

The mechanism used as the reference is not necessarily a flush. It is possible to use any mechanism that operates with operating cycles, each presenting a cycle duration that is substantially constant and during each of which the individual consumption of the mechanism is substantially constant. By way of example, the mechanism could be an automatic sprinkler system.

The fluid meter may measure the consumption of a fluid that is not necessarily water, but that could be some other liquid, a gas, oil, etc.

1. A monitoring method for monitoring a measuring device of a fluid meter that is arranged to produce measurements of the overall consumption of an installation, the method comprising the steps of:
analyzing the overall consumption measurements to identify a mechanism in the installation that operates with operating cycles, each presenting a substantially constant cycle duration (t₁−t₀) and during each of which the individual consumption (V₁−V₀) of the mechanism is substantially constant;
detecting the operating cycles of the mechanism and measuring the individual consumption of the mechanism for each detected operating cycle;
detecting abnormal metrological drift of the measuring device of the fluid meter as a function of variation over time in the individual consumption of the mechanism.

2. The monitoring method according to claim 1, wherein identifying the mechanism comprises the steps of:
detecting, in the overall consumption measurements, a reference operating cycle having a cycle duration and an individual consumption that are substantially equal to a previously-input cycle duration and to a previously-input individual consumption corresponding to a known mechanism;
associating the mechanism with a reference cycle duration (t̅) equal to the cycle duration of said reference operating cycle and with a reference individual consumption (V̅) equal to the individual consumption of said reference operating cycle.

3. The monitoring method according to claim 1, wherein detecting an operating cycle comprises the steps of detecting, in the overall consumption of the installation, a succession of a first stable stage, of an increasing stage, and of a second stable stage.

4. The monitoring method according to claim 1, further comprising a step of detecting a change of mechanism from a variation in the cycle duration and/or from a variation in the individual consumption of the mechanism.

5. The monitoring method according to claim 4, wherein an identical replacement of the mechanism is detected when, starting from a first change time, the cycle duration no longer lies in a first interval centered on the reference cycle duration and the individual consumption no longer lies in a second interval centered on the reference individual consumption.

6. The monitoring method according to claim 5, wherein replacement of the mechanism by a non-identical mechanism is detected when, from a second change time, the cycle duration no longer lies in a third interval centered on the reference cycle duration and the individual consumption no longer lies in a fourth interval centered on the reference individual consumption, the third interval and the fourth interval being wider than the first interval and the second interval.

7. The monitoring method according to claim 1, wherein detecting abnormal metrological drift comprises the steps of:
evaluating a drift function (Pₙ) representative of drift of the individual consumption of the mechanism;
detecting abnormal metrological drift when the drift function remains less than or equal to a predetermined threshold for a predetermined duration, and then, starting from a drift time (t_{d}) and under the effect of abnormal metrological drift, the individual consumption no longer lies in a fifth interval centered on the reference individual consumption.

8. The monitoring method according to claim 7, wherein the drift function is an average of the slopes of segments, each connecting together two successive measurement points, each measurement point having as its coordinates the time at which an individual consumption measurement is taken, and said individual consumption measurement.

9. The monitoring method according to claim 1, wherein the mechanism is a flush.

10. A fluid meter including a measuring device and a processor module arranged to perform the monitoring method according to claim 1.

11. A computer program including instructions for causing the fluid meter according to claim 10 to execute a monitoring method for monitoring a measuring device of a fluid meter that is arranged to produce measurements of the overall consumption of an installation, the method comprising the steps of:
analyzing the overall consumption measurements to identify a mechanism in the installation that operates with operating cycles, each presenting a substantially constant cycle duration (t₁−t₀) and during each of which the individual consumption (V₁−V₀) of the mechanism is substantially constant;
detecting the operating cycles of the mechanism and measuring the individual consumption of the mechanism for each detected operating cycle;
detecting abnormal metrological drift of the measuring device of the fluid meter as a function of variation over time in the individual consumption of the mechanism.

12. A computer readable storage medium having stored thereon the computer program according to claim 11.
